(19) United States
(12) Patent Application Publication
(10) Pub. No.: US 2003/0143032 A1
(43) Pub. Date: Jul. 31, 2003

(54) Swivel connection

(76) Inventor: Bjorn Palmquist, Goteborg (SE)

Correspondence Address: Samuels, Gauthier & Stevens LLP, Suite 3300, 225 Franklin Street, Boston, MA, 02110, US

(21) Appl. No.: 10/336,425

(22) Filed: Jan. 3, 2003

Related U.S. Application Data
(63) Continuation of application No. PCT/SE01/00963, filed on May 4, 2001.

(30) Foreign Application Priority Data
Jul. 7, 2000 (SE) 0002566-8

(51) Int. Cl. F16L 1/12; E02D 23/02; B63B 21/00

(52) U.S. Cl. 405/169; 405/206; 114/230.12; 405/224.2

(57) ABSTRACT

The present invention relates to a ball swivel connection/joint intended to be used at anchoring of in particular deep sea water boring rigs and other off-shore platforms but also other heavy units at sea, whereby it comprises a partly spherical wire connection receiving a wire receiving unit a substantially annular link connector as well as a holding element for a fixed or movable fixation of the link connector as well to an annular space arranged in the partly spherical connector, whereby the link connector and the wire receiving unit are rotatably arranged relative each other.

### TECHNICAL FIELD

The present invention relates to a ball swivel joint/connection intended to be used at anchoring of in particular deep sea water boring rigs and other off-shore platforms but also other heavy units at sea.

The object of the present invention is to obtain a ball swivel joint/connection which facilitates the taking in lifting of anchoring chains at anchoring of in particular deep sea water boring rigs and other off-shore platforms but also other, heavy units at sea.

Further objects will be evident from the accompanying description.

### BACKGROUND OF THE INVENTION

At deep water anchoring of boring rigs and production platforms for oil recovery a wire having a large diameter is used to withstand the forces the anchoring is made subject to at the rolling out of such a wire torsions will always occur which torsions are transferred to the wire as such and can lead to that the wire is winded up against its drawn direction. At any later unloading the wire may then obtain a knot which breaks wire threads.

To prevent this some sort of torsion allowance has to be added in the form of a swivel joint at unloading.

Some floating off-shore units are anchored using 8 to 12 wires (2 to 3 wires in each corner of the unit) connected at their opposite ends via a chain to an anchor The diameter of the wires varies commonly between from about 64 to 90 mm and the length is most often at about 2000 to 2300 m.

When the wire is subjected to different drafts the wire torsions and varies with regard to diameter and length.

An anchoring wire cost about 500,000 to 700,000 Swedish crowns (SEK), and thus it is of utmost importance that the wire does not become damaged. Damages may appear by pure wearing out but also from exhaustion if the construction is not completely reliable.

At the anchoring of deep water boring rigs and other offshore platforms large, heavy and long chains are used closest to the anchor, which chains are connected with its rig via long powerful wires. When the wire is to be brought home to the platform there is a requirement that any torsion of the chain and wire shall be able to be eliminated and hat the wire must not be made subject to breaking forces.

This is achieved in accordance with the prior art by having the wire provided at its end with a so called t all connector which is a semi spherical unit in which the wire is attached to and in which connector a chain link is connected (FIG. A). In this link a swivel is then connected, a swivel being a rotatable connector that allows for elimination of torsions of the wire/chain system. Behind the swivel connector there is a further link which in turn is connected to a so called pear ink or three holes plan, which connects to the chain leading to the anchor via a dismountable link of security reasons there is, parallel to the wire connection which normally attracts the tension forces between rig and anchor, a further chain which via a link is attached to said pear link or three holes disc.

When bringing home the anchor and lifting up of the chain the chain and the wire is brought home simultaneously (FIG. B), whereby, as the wire has been brought home to a substantial part (FIG. C) the load is transferred to the chain so that the ball connector shall tie able to be brought over the wire drum without any breaking forces being added upon the wire/ball connector.

By using a ball connector connected in combination with a swivel and with inter-situated links weakening points are obtained in the chain-wire system. From an insurance point of view and from a sea security point of view only a limited amount of such “weak” points are allowed to be used in certain cases on a chain-wire length and in those cases when a chain has broken and been repaired e.g., more than once to twice it has become exchanged due to the fact that the number of weak points exceeds the number allowed from a security point of view.

### DESCRIPTION OF THE PRESENT INVENTION

It has now turned out possible to be able to eliminate this problem by means of the present invention which is characterized in that it comprises a partly spherical wire connection receiving a wire receiving unit, a substantially annular link connector as well as a holding element for a fixed or movable fixation of the link connector to an annular space arranged in the partly spherical connector, whereby the link connector and the wire receiving unit are rotatably arranged relative each other.

Further characteristic are evident from the accompanying claims.

By means of the present invention it is achieved on one hand that the wire, when it passes through the fairled of the rig is not subjected to breaking forces, on the other hand that rotational movements are eliminated by means of the built-in swivel function. The number of “weak” points are eliminated to a minimum as well, which means that the number of points of repair can be extended.

The present invention will be described more in detail in the following with reference to the accompanying drawing, however, without being restricted hereto.

In the drawing

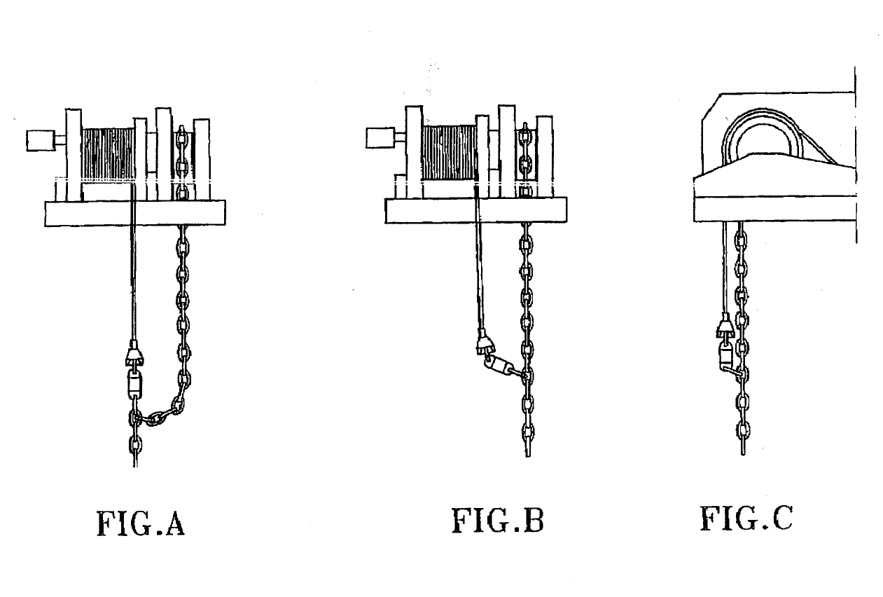

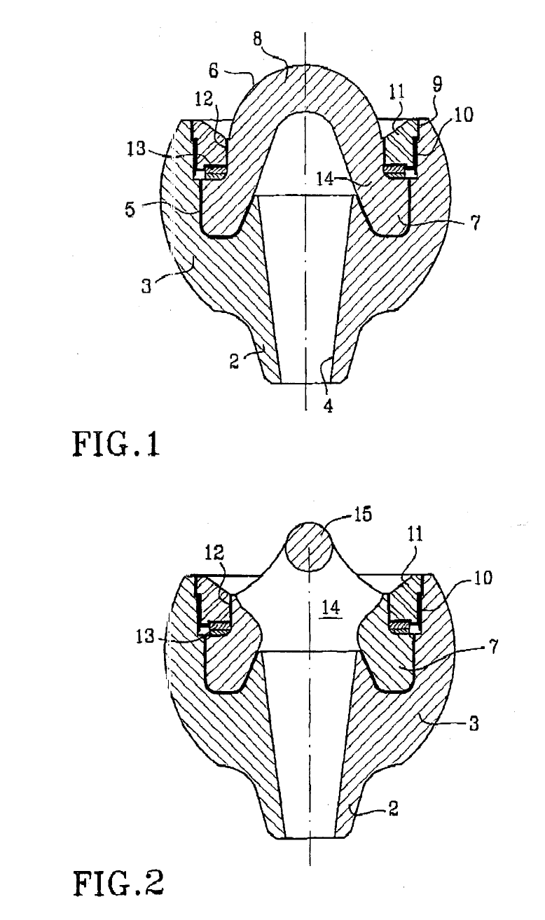

FIG. 1 show a Gross-section of a preferred embodiment of the invention;

FIG. 2 shows a cross-section 90° to the cross-section of FIG. 1;

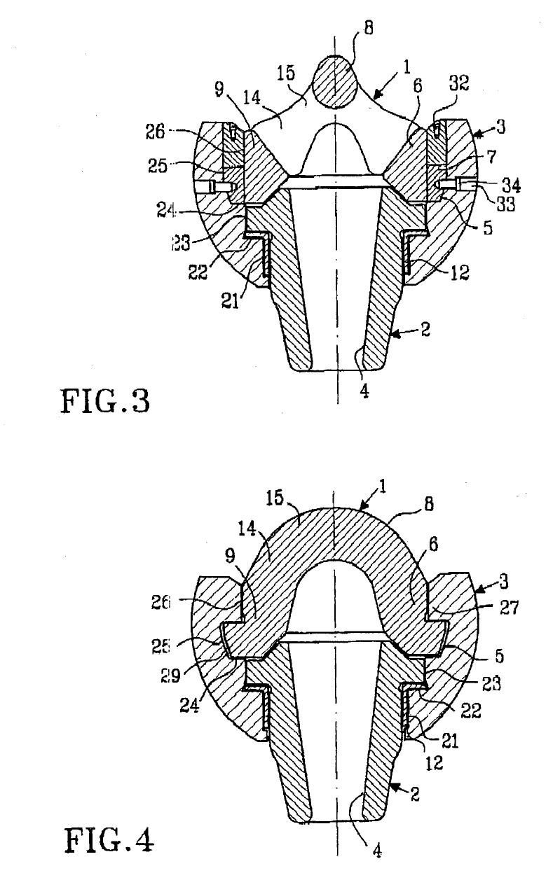

FIG. 3 shows a cross-section though another preferred embodiment of the invention;

FIG. 4 shows a cross-section 90° to the cross-section of FIG. 3:

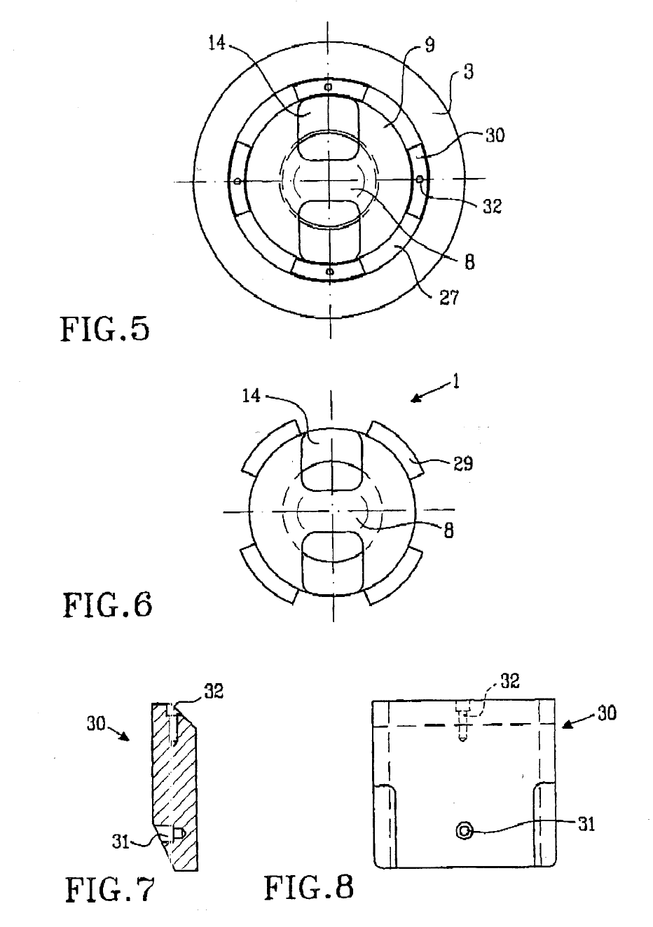

FIG. 5 shows the embodiment of FIG. 3 seen from above;

FIG. 6 shows the link connector of the embodiment of FIG. 3 seen from above;

FIG. 7 shows a cross-section of a locking segment of the embodiment of FIG. 3; and

FIG. 8 shows the locking segment of FIG. 7 seen from the side.

The drawing further comprises figures related to the prior art, wherein

FIG. A shows a principal sketch of a chain-wire-length connector according to the prior art,

FIG. B shows the bringing home of a chain-wire-length where the load is on the wire: and

FIG. C shows the bringing home of the chain-wire-length where the load is on the chain.

In FIGS. 1 and 2, 1 denotes a partially spherical wire connector comprising a stem 2 and a partially cylindrical, partly cut spherical part 3, whereby the stem 2 and the sphere 3 receives a conical space 4 for receiving a wire which is secured to the connector 1 by means of moulding using a metal such as zinc or an epoxy polymer. Outside and around the widest mouth of the conical space 4 of the sphere 3 there is an annular space 5 in the spherical part, which annular space is arranged to receive a link connector 6 comprising an annular part 7 adapted to said space 5, and comprising a link 8 being placed diametrically above the annular part 7.

Thereby the link 8 starts from a broad base 14 of the annular part 7 and transforms into a linking part 15. The link connector 6 with its link 8 is arranged to receive a link, e.g., a pear link of a chain package. The annular space 5 transforms into a cylindrical part 9, which partly is provided with a thread 10, which is arranged to receive a screw ring 11. The cylindrical part 9 has, in the embodiment shown a larger diameter than the annular space 5 substantially in order not to damage the thread 10 at insertion and extraction of the link connector 6 out of the annular space 5. The link connector 6 is arranged to be able to rotate in the annular space 5 via the annular part 7 whereby the surfaces between these parts may be provided with a friction reducing element 12, or the materials are chosen in such a way relative each other that least possible friction and corrosion welding takes place.

Between the annular part 7 and the screw ring 11 friction-reducing elements 13 can be arranged as well it is important that the swivel function can be achieved even when subjected to great tension force in the chain-wire connector.

In FIGS. 3 and 4, 1 denotes a partially spherical wire connector comprising a substantially partially spherical unit in the form of a cut spherical part 3, which in its inner receives a number of abutment surfaces 21, 22, 23, 24, 25, 26 for receiving on one hand a stem 2 and on the other hand a link connection 6. The stem 2 is locked/blocked in the partly spherical unit 1, 3 by the link connection by means of a bayonet lock of the layer to the partly spherical unit 1, 3. For this purpose the partly spherical unit 1, 3 is provided with bayonet ears 27 between which the link connection 6 is arranged to be brought down into and is arranged to be turned in underneath the bayonet ears 27 and into an annular space 5 arranged in the spherical part, which space 5 is arranged to receive the bayonet ears 29 adapted to said space 5 of the annular part 7 of the link connection 6. The link connection 6 comprises in accordance with above a link 8 as well which is placed diametrically above the annular part 7. The link connection 6 is locked to the partly spherical unit 1,3 by means of locking segments 30 which are arranged to be introduced between the bayonets ears 27 and are provided with on one hand a threaded screw hole 31 for receiving a locking screw 34, on the other hand a threaded hole 32 to make possible/facilitate extraction of the locking segment from the space between the bayonet ears 27. Hereby the partly spherical unit 1, 3 is provided with the corresponding holes 33 for receiving said locking screw 34 as well.

The partly spherical connecting part has in the common case a diameter of about 500 to 600 mm and a length of about 550 to 650 mm. The link connection 6 has an outer diameter in the annular part 7 of 350 to 425 mm and has an inner diameter of 150 to 200 mm, and has a height of 250 to 350 mm.

1. Swivel connection/joint intended to be used at anchoring of in particular deep sea water boring rigs and other off-shore platforms but also other heavy units at sea, characterized in that it comprises a partly spherical wire connection (1,3) receiving a wire receiving unit (2), a substantially annular link connector (6,7) as well as a holding element (11) for a fixed or movable fixation of the link connector (6) to an annular space (5) arranged in the partly spherical connector (1,2,3) perpendicular to the wire receiving unit (2), whereby the link connector (6) and the wire receiving unit (2) are rotatably arranged relative each other.

2. Joint according to claim 1, characterized in that the holding element (11) is a screw ring arranged for rotatably attachment of said link connector.

3. Joint according to claim 1, characterized in that the partly spherical wire connection (1,2,3) is on one hand a substantially spherical unit (1,3), on the other hand a wire receiving stem unit (2) which later is movably mounted in said first mentioned unit (1,3).

4. Joint according to claim 1, characterized in that friction reducing elements (12,13) are present between the partly spherical connection (1,2,3) and the link connection (6) and/or wire receiving stem unit (2).
